(19) United States
(12) Patent Application Publication
(10) Pub. No.: US 2018/0104566 A1
(43) Pub. Date: Apr. 19, 2018

(54) SKATEBOARD SIDE-MOTION ROLLER ASSEMBLY

(71) Applicant: Stephen Hardy Pielstick, South Weber, UT (US)

(72) Inventor: Stephen Hardy Pielstick, South Weber, UT (US)

(21) Appl. No.: 15/723,517

(22) Filed: Oct. 3, 2017

Related U.S. Application Data
(60) Provisional application No. 62/409,667, filed on Oct. 18, 2016.

(51) Int. Cl. A63C 17/00; F16C 19/06; F16C 35/04

(52) U.S. Cl. CPC A63C 17/0006; A63C 17/01; F16C 35/042; F16C 19/06

(57) ABSTRACT

The present invention is directed to devices for protection of the bottom center portion of skateboard platforms when used obliquely on upstanding structural edges, as when grinding. A roller assembly of the present invention may have an elongated bearing shaft rotatably positioned at each end in spaced apart bearings that are attached to the bottom surface of a skateboard platform. Optional variations and surface treatments of the bearing shaft are also disclosed.

### RELATED APPLICATION

This application claims the benefit of U.S. Provisional Application No. 62/409,667, filed Oct. 18, 2016, which is incorporated herein by reference.

### BACKGROUND OF THE INVENTION

This invention relates to devices for pedestrian powered vehicles, particularly skateboards, to aid in using a skateboard to slide sideways or obliquely on a railing, beam, street curb, or other like structural edge. The new roller assembly attaches to the bottom of a skateboard in a position to engage a structure located under the skateboard.

Skateboards are generally in the form of an elongated flat thin platform of material such as wood or composite material with a wheel assembly attached adjacent to a front and rear end on the bottom surface. Persons using skateboards are known to use the bottom surface of the skateboard to slide obliquely or sideways on upstanding surfaces of structures such as railings, beams, street curbs and the like. When a user performs such a riding maneuver the bottom surface of the skateboard between the two opposed wheel assemblies is the part of the skateboard structure that slides on the intended structural edge. This use of a skateboard, often referred to as “grinding”, may accelerate the wear and deterioration of the skateboard structure. It would be useful to incorporate a structure under the skateboard platform, generally between the wheel assemblies that would aid in oblique movement of the skateboard on upstanding structural edges.

This invention may also be adapted to other pedestrian powered vehicles such as skates and scooters that may also be used in grinding fashion.

### SUMMARY OF THE INVENTION

The present invention is directed to devices for structural support and protection of the bottom center portion of skateboard platforms when used obliquely on upstanding structural edges. A roller assembly of the present invention comprises a rotatable contact surface and a bearing means. The contact surface may be an elongated bearing shaft rotatably secured at each end by spaced apart bearing means to a bottom surface of a skateboard platform. Alternatively, the roller assembly may have an elongated bearing shaft fixedly attached at each end to the bottom surface of a skateboard platform, with a bearing shaft sleeve rotatably positioned about internal bearings, which bearings are in contact with the fixed, elongated bearing shaft. At least one roller assembly is positioned approximately longitudinally to the bottom surface of said skateboard platform, generally perpendicular to the side-motion or oblique directions of travel.

These and other features, aspects and advantages of the present invention will become better understood with reference to the following drawings, description and claims.

### BRIEF DESCRIPTION OF THE DRAWINGS

FIG. 1 illustrates a bottom perspective view of a skateboard with a single side-motion roller assembly having an elongated bearing shaft and bearing sleeve attached by brackets between the wheel assemblies according to an embodiment of the invention;

FIG. 2 illustrates a side elevation view of a skateboard with a roller assembly attached between the skateboard wheel assemblies according to an embodiment of the invention;

FIG. 3 illustrates a detailed cross-section view of a bearing shaft rotatably connected to a bracket wherein the bracket functions as a bearing housing according to an embodiment of the invention.

FIG. 3a illustrates a detailed cross-section view of a bearing shaft rotatably connected to a bracket wherein the end of the elongated bearing shaft functions as a bearing housing according to an embodiment of the invention.

FIG. 4 illustrates a front elevation view of a skateboard with a pair of roller assemblies attached to the bottom surface, spaced apart above the wheels according to an embodiment of the invention;

FIG. 5 illustrates a rear elevation view of a skateboard with a pair of roller assemblies attached to the bottom surface of a skateboard spaced wide apart above the wheels according to an embodiment of the invention.

### DETAILED DESCRIPTION

The following detailed description represents the best currently contemplated modes for carrying out the invention. The description is not to be taken in a limiting sense, but is made merely for the purpose of illustrating the general principles of the invention.

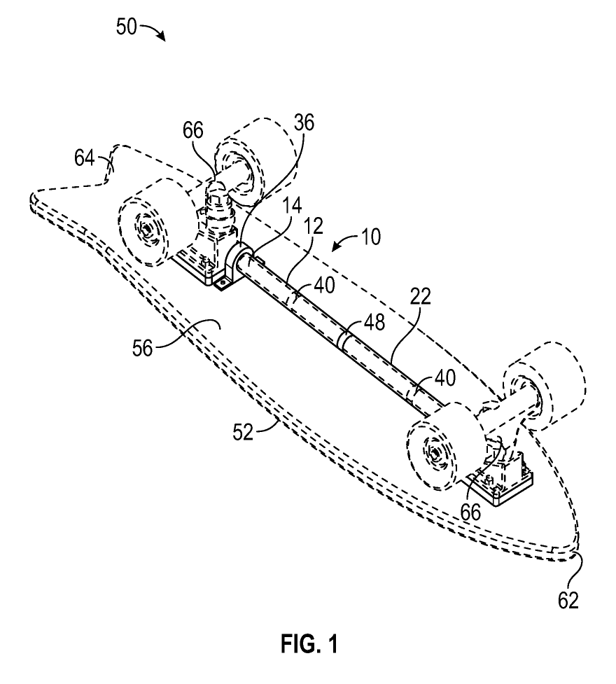

In the configuration depicted in FIG. 1, an at least one roller assembly 10 comprising a contact surface and a bearing means. The roller assembly 10 may comprise an elongated bearing shaft 12 fixedly attached by brackets 36 at each end 14 to the bottom surface 56 of a skateboard platform 52, between front and rear wheel assemblies 66. A bearing sleeve 22 may be rotatably positioned in contact internally with bearings 40 that are positioned in contact with and about the elongated bearing shaft 12. Preferably, two or more internal bearings 40 would be positioned between the elongated bearing shaft 12 and the bearing sleeve 22.

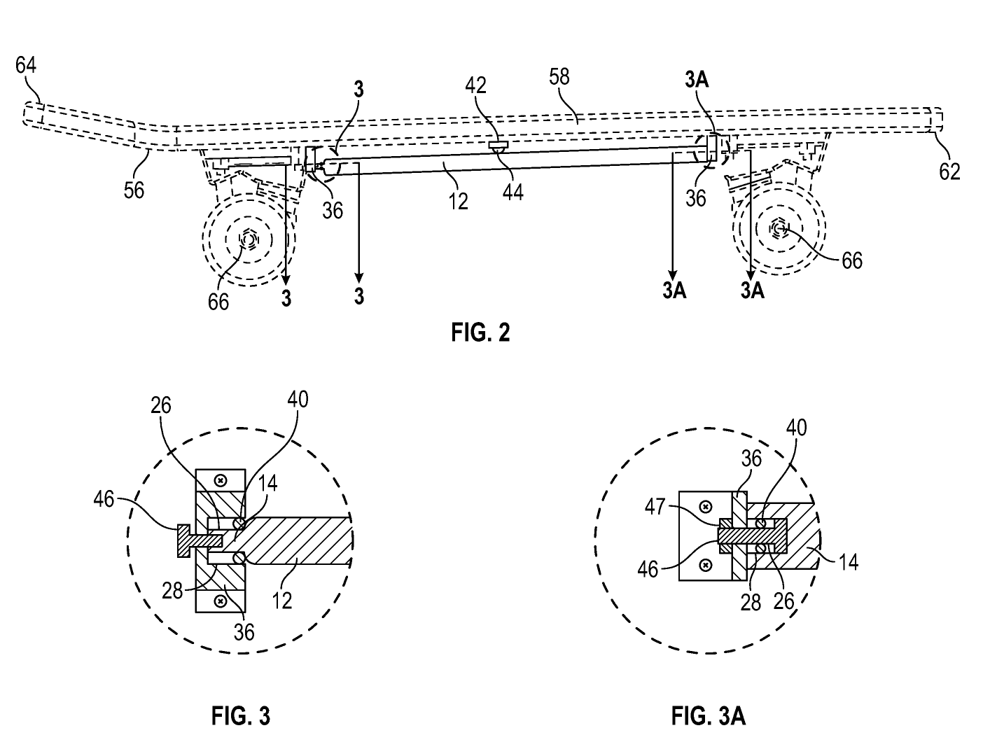

Referring to FIGS. 2 through 5, the at least one roller assembly 10 may comprise an alternative contact surface for engaging an upstanding structural edge. The alternative contact surface comprises an elongated bearing shaft 12 rotatably secured by bearing means at each end 14 in longitudinally spaced apart brackets 36 attached to the bottom surface 56 of a skateboard platform 52.

The bearing means may comprise a bearing assembly including an outer race 28 and bearings 40 positioned therein retained by an inner race 26 as is generally understood for ball bearing assemblies. The ball bearing assembly may be housed in either the bearing shaft end 14, or housed in the bracket 36. In one embodiment of the invention, shown in FIG. 3, the bracket 36 is provided with an opening in one side to receive the bearing shaft end 14 of the elongated bearing shaft 12. The bearing shaft end 14 may have a smaller diameter compared to the body 20 of the shaft. Each end 14 may be inserted in the bracket 36 and retained by a fastener 46. The bracket 36 houses the bearing means, and acts as one component of the bearing assembly, having an inside surface that defines the bearing outer race 28, with the shaft end 14 acting as another component of the bearing assembly with its circumference defining the bearing inner race 26. In another embodiment of the bearing means, shown in FIG. 3a, the bearing shaft end 14 is bored at its axis to create the outer race 28, and a fastener 46 may be inserted therein to form the inner race 26. The bearings may be balls or cylinders as are generally known in the art. Optionally, complete bearings may be substituted, rather than fabricating the bearing shaft, brackets and fasteners to serve as bearing races.

With the at least one roller assembly 10 attached to a skateboard bottom surface 52 as best illustrated in FIG. 1, the roller assembly 10 would be positioned for engagement with an upstanding structural surface or edge that would be narrow enough to fit between the wheel assemblies 66 of a skateboard 50 when the skateboard 50 is moved obliquely relative to the upstanding structural surface. Optionally, the roller assembly 10 could be selectably sized either short enough to be positioned between the wheel assemblies 66 or longer to be installed with brackets 36 at positions alongside the wheel assemblies 66 or nearer the front 62 or rear 64 of the skateboard platform 52.

The bearing sleeve 22 of FIG. 1 or the elongated bearing shaft 12 of FIGS. 2, 3 and 3A may be treated to impart greater gripping ability to prevent the skateboard from slipping longitudinally when engaged with a structure. The gripping treatment may be selected from known rubber or polymer materials known to those skilled in the art, and may be applied by such means as spraying, dipping, and heat-shrinking. Further, the gripping treatment would be characterized by its further ability to be reapplied or replaced after damage or deterioration from use.

As a further, optional, embodiment of the invention, the mounting brackets 36 may be replaced by modified wheel assemblies 66 that have been prepared to receive the bearing shaft ends 14 or bearing means directly.

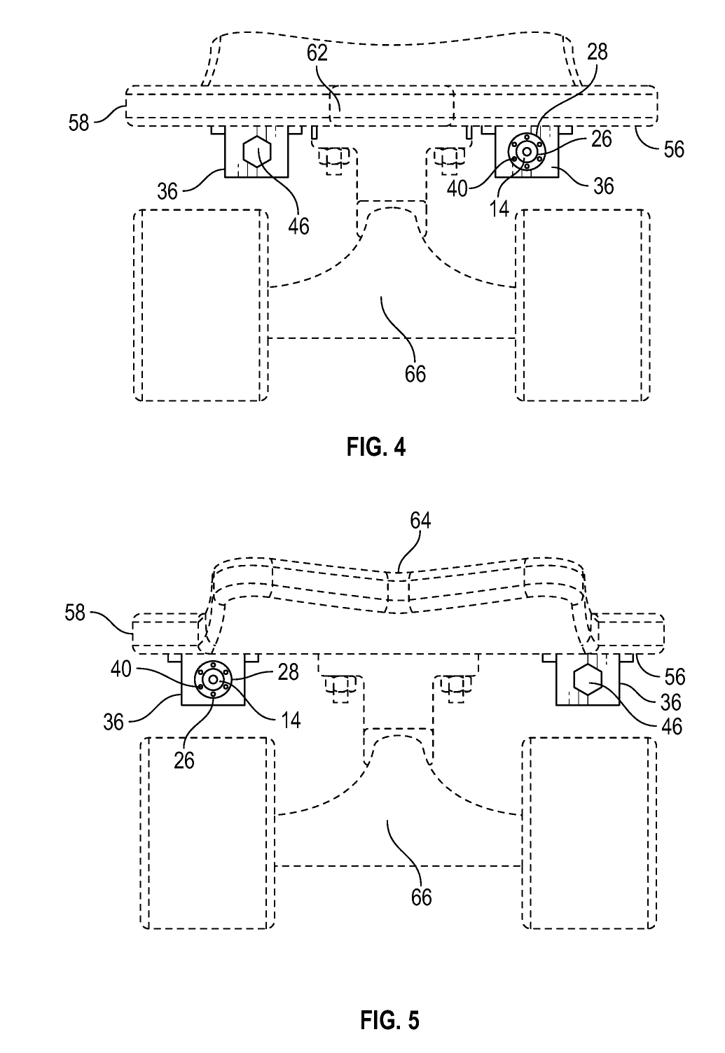

The rotational stability of the skateboard 50 when used for grinding with the present invention is increased by the addition of a second roller assembly 10, and further still by increasing the spacing between a first and second roller assemblies 10. Two or more roller assemblies 10 may be sized to fit adjacent one another between the front and rear wheel assemblies 66. Alternatively, the second roller assembly 10 may be attached spaced apart from a first roller assembly 10 to the bottom surface 56 of a skateboard platform 52, as shown in FIG. 4. The first and second roller assemblies 10 may optionally be spaced further apart laterally and positioned proximal to the sides 58, of the skateboard 50, as best viewed in FIG. 5. In a yet further embodiment, a plurality of roller assemblies 10 may be attached to the skateboard bottom surface 52 in any user-selected configuration.

The elongated bearing shaft 12 or tubular bearing sleeve 22 may have a groove 48 formed therein about its circumference to guide the skateboard 50 when traversing along a selected upstanding surface edge feature in an oblique manner on a structure. The groove 48 may be as narrow as a single notch. In another embodiment, the groove 48 may be so wide and shallow as to impart a shape upon the elongated bearing shaft that is narrower at its middle and wider at its ends. Such shapes may include hyperboloid, catenoid and double conical shapes.

One or more ball bearing units comprising a base 42 and a retained ball 44 may be attached at the bottom surface 56 of the skateboard 50 positioned above the at least one elongated bearing shafts 12 for the elongated bearing shaft 12 to rotate against the retained ball 44 for additional structural support, as best illustrated in FIG. 2. The elongated bearing shaft 12 may be formed of a stiff, strong material such as steel, or from other strong yet light materials selected from metals and alloys known in the art of metallurgy.

The elongated bearing shaft 12 may be retained in position in the brackets 36 by fasteners 46, for example, bolts, screws and the like threaded into the bearing shaft ends 14 as illustrated in FIG. 3. Optionally, the fastener 46 may be inserted in reverse fashion as shown in FIG. 3A, secured opposite the bracket by a nut, cotter pin, clip or similar retainer. A cylindrical elongated bearing shaft 12 may be approximately three-eighths inch (⅜″) to one inch (1″) in diameter, preferably one-half inch (½″) to one inch (1″) in diameter. A shaped elongated bearing shaft 12 may require greater circumference, depending on the depth of the profile of the shape to be imparted.

While the invention has been particularly shown and described with respect to the illustrated embodiments thereof, it will be understood by those skilled in the art that the foregoing and other changes in form and details may be made therein without departing from the spirit and scope of the invention.

I claim:

1. A roller assembly to protect a bottom surface of a skateboard platform when a skateboard is engaging an upstanding structural edge, said roller assembly comprising
(a) A contact surface for contact between the skateboard and the upstanding structural edge; and
(b) A bearing means.

2. A roller assembly of claim 1 wherein the contact surface comprises an elongated bearing shaft rotatably disposed within the bearing means, and the bearing means comprises a ball bearing housing.

3. A roller assembly of claim 2 wherein the ball bearing housing is mechanically fastened to the bottom surface of a skateboard platform.

4. A roller assembly of claim 2 wherein the ball bearing housing is an integral feature of a wheel assembly of the skateboard.

5. A roller assembly of claim 1 wherein the contact surface comprises a tubular bearing sleeve rotatably disposed about and in contact with an elongated bearing shaft through the bearing means.

6. A roller assembly of claim 5 wherein the bearing means comprises at least two internal bearings between the elongated bearing shaft and the tubular bearing sleeve.

7. A roller assembly of claim 5 wherein the elongated bearing shaft is mechanically fastened in a fixed position to the bottom surface of a skateboard platform by a bracket.

8. A roller assembly of claim 5 wherein the elongated bearing shaft is mechanically fastened in a fixed position to a wheel assembly of the skateboard.

9. A roller assembly of claim 1 wherein a non-slip treatment is applied to the contact surface.

10. A roller assembly of claim 9 wherein the non-slip treatment is a viscous coating.

11. A roller assembly of claim 9 wherein the non-slip treatment is a heat-sensitive polymer material.
